(19) United States
(12) Patent Application Publication
(10) Pub. No.: US 2006/0020886 A1
(43) Pub. Date: Jan. 26, 2006

(54) SYSTEM AND METHOD FOR THE STRUCTURED CAPTURE OF INFORMATION AND THE GENERATION OF SEMANTICALLY RICH REPORTS

(76) Inventors: Subodh K. Agrawal, Bogart, GA (US); Prem P. Yadav, Watkinsville, GA (US); Shyam P. Prabhakar, Athens, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 11/160,869

(22) Filed: Jul. 13, 2005

Related U.S. Application Data
(60) Provisional application No. 60/588,286, filed on Jul. 15, 2004.

(51) Int. Cl. G06F 17/24

(52) U.S. Cl. 715/530

(57) ABSTRACT

The present invention generally relates to systems and methods for the customization of structured data entry screen templates. The systems and methods include the hierarchical organization of data capture fields, the defining of macro-embedded sentences at each hierarchical level in addition to a set of rules for generating and aggregating sentences. Lastly, the raw captured data and macro-embedded sentences are stored and then merged together with style sheets to generate semantically rich, natural-language documents.

### CROSS-REFERENCE TO RELATED PATENT APPLICATION

This application claims the benefit, pursuant to 35 U.S.C. §119(e), of U.S. Provisional Patent Application entitled “SYSTEM AND METHOD FOR THE WEB-BASED STRUCTURED CAPTURE OF INFORMATION AND GENERATION OF SEMANTICALLY RICH REPORTS” filed on Jul. 15, 2004, and assigned Ser. No. 60/588,286, the disclosure of which is incorporated herein by reference in its entirety.

### FIELD OF INVENTION

The present invention generally relates to the field of information systems report generation, wherein structured methods are used to capture information. The captured information can be quickly retrieved and thereafter used to generate semantically rich, natural-language reports.

### BACKGROUND OF THE INVENTION

Currently, there are a plethora of industries where it is essential to capture, process and employ wide assortments of data gathered from individuals in order to perform specific functions or tasks. Accordingly, it is very important that the captured information, to be of any value to an appraiser, be presented in a systematic, easily assessable and perusable reporting format. Industries that rely heavily on compiled personal data reports to accomplish tasks (e.g., insurance information reporting agencies, medical fields, human resource departments, etc. . . . ) have a vital need for an automated means with which to capture a variety of an individuals personally-related data and subsequently present the data for review to an authorized professional.

For example, in the medical field a common method for the capture of patient data is through the use of handwritten notes. A patient's caregiver will write notes that encompass the patient's data on sheets of paper that are placed in the patient's medical chart for later reference. This method of data capture, while the simplest, is not very efficient. Further, the reports are prone to the errors caused by illegible handwriting and other problems (e.g., such as misplaced charts) that could affect the quality of service that is provided to a patient. Further, since there is only the one instance of a patient's record, it is difficult for other caregivers who are sharing in the care of the patient to keep informed on a timely basis as to the patient's treatment and progress.

The use of dictation and transcription and voice recognition devices is also a prevalent means to capture patient healthcare information. Using one of these devices, a caregiver dictates notes describing an encounter with a patient. The recorded note is later transcribed into a report. A shortcoming of these methods is that the patient's clinical information is not stored in an original and immediately accessible form and this can hinder the retrieval of the original information, especially if there has been an error made in the transcription of the original information.

Other currently available tools that aid in the entry of personal data into reports are software packages that use computer-based templates for the entry of an individual's personal data. However, these systems are typically hard-coded with various data entry screens. Consequently, many of theses systems do not provide a user with the flexibility to customize templates within the software packages. For example, the quality of reports generated by many electronic medical records (EMR) systems is poor as compared to dictation/transcription systems. Further, reports that are generated by current technologies have a tendency to be stilted with lists of items rather than presenting the acquired personal information in a semantically rich, natural-language reporting format.

Therefore, there exists the need for a user customizable, data capturing computer interface system in which the an individuals personal information is captured by the interface and then stored, processed, interpreted and reported in a timely manner to a system user. Further, the report should be in a highly legible, professional natural-language format that provides for the organizing, distribution and sharing of the information between other authorized professionals.

### SUMMARY OF THE INVENTION

The present invention generally relates to systems and methods for the customization of structured data entry screen templates. The systems and methods include the hierarchical organization of data capture fields (macros), the defining of macro-embedded sentences at each hierarchical level in addition to a set of rules for generating and aggregating sentences. Lastly, the captured raw data and macro-embedded sentences are merged together with style sheets to generate semantically rich, natural-language documents.

According to one aspect of the present invention comprises a method for the generation of a grammatically appropriate natural-language text document based in part on information input by a user. The method comprises the steps of providing at least one workstation for presenting information to a user and for receiving data input by the user via an associated data entry device and providing a findings repository for storing information input by the user. Further, the method provides a template repository for the step of storing at least one natural-language sentence template preformatted in a grammatically appropriate structure having a plurality of predetermined word locations populated with predetermined words for a sentence and at least one variable data capture field for receiving information provided by the user in a data entry operation. A document repository is provided for the storage of text documents that have been generated in the method.

Additionally, on the workstation, a user interface is displayed comprising at least one first data capture field in association with prompting information that is used to prompt the user as to what information should be provided in the first data capture field. In response to input by the user of particular first information in the first data capture field, the particular first information is stored in a data record in the findings repository and associated with a corresponding variable data capture field or macro in a natural-language sentence template.

Further, in response to input by the user of particular first information in the first data capture field, determining whether to obtain additional information from the user by displaying at least one related second data capture field in association with prompting information for prompting the user as to what information should be provided in the second data capture field. Also, in response to input by the user of particular second information in the second data capture field, the method provides a step for storing the particular second information in a data record in the findings repository and associating the particular second information with a corresponding variable data field in a natural-language sentence template.

Retrieving data records of information input by a user generates a text document by inserting retrieved data into a plurality of grammatically appropriate sentences arranged in a predetermined format. Lastly, the text document is stored within the document repository and provided as a report output.

A further aspect of the present invention relates to a computer-implemented method for generating a natural-language written document based on information input by a user in response to computer-assisted querying. The computer-implemented method provides the means for the user to create logical trees and sentence templates that are used as indicated herein. The computer-implemented method comprises the steps of storing a plurality of information queries arranged in a logical tree having non-terminal nodes and terminal nodes. It further comprises the information queries including data input controls for receiving user data input and displaying at least one non-terminal information query associated with a non-terminal node of the tree. The non-terminal information query comprises a table having at least two rows. The first row of the table has a caption and the second row of the table has a content area associated with the caption.

Further, the method provides for displaying a first related non-terminal information query associated with a non-terminal node of the tree as nested within the content area of the content row, for displaying additional related terminal information queries associated with terminal nodes of the tree as nested within the content area of the content row, and for receiving of user data input by the data input controls in response to the displaying steps. In response to user input of particular information a determination is made whether a related additional question is applicable or whether a terminal node has been reached, and further repeating the above steps until a terminal node is reached.

In response to reaching a terminal node, the method provides for storing data from user input of information in a findings repository and, upon reaching a final terminal node of the logical tree, generating a document. The document is generated by the steps of retrieving a predetermined sentence template containing predetermined portions of a natural-language sentence or other grammatical structure, having embedded macros for receiving particular information stored in the findings repository and then retrieving information corresponding to the embedded macros from the findings repository. Further, the data fields in the template are populated with the retrieved information to provide a grammatically appropriate structure for a sentence and a plurality of completed natural-language sentences are stored as a part of a document in a document repository.

Aspects of the present invention further comprise a document repository for storing generated text documents. The information from the findings repository is merged into the sentence templates to generate a hypertext markup language (HTML) file, which is converted into a word processing document in a predetermined word processing file format, and the word processing document is stored in the document repository.

### DETAIL DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 is a diagram illustrating aspects of a system that may be implemented within embodiments of the present invention.

FIG. 2 illustrates an aspect of a system that may be implemented within embodiments of the present invention.

FIG. 3 is a diagram of a template tree representation of an aspect of the present invention.

FIG. 4 is a diagram of a template tree representation of an aspect of the present invention.

FIG. 5 is a diagram of a template tree representation of an aspect of the present invention.

FIG. 6 is a diagram of a template tree representation of an aspect of the present invention.

FIG. 7 is a screen display of the graphical representation of the template tree that can be implemented within aspects of the present invention.

FIG. 8 is a screen display of the graphical representation of the template tree that can be implemented within aspects of the present invention.

FIG. 9 is a screen display of a graphical representation of a input screen that can be used to edit information within a template tree that can be implemented within aspects of the present invention.

FIG. 10 is a screen display of a graphical representation of a input screen that can be used to edit information within a template tree that can be implemented within aspects of the present invention.

FIG. 11 is a screen display of a graphical representation of a input screen that can be used to edit information within a template tree that can be implemented within aspects of the present invention.

FIG. 12 is a screen display of the graphical representation of the template tree that can be implemented within aspects of the present invention.

FIG. 13 is a screen display of the graphical representation of the template tree that can be implemented within aspects of the present invention.

FIG. 14 is a screen display of the graphical representation of the template tree that can be implemented within aspects of the present invention.

FIG. 15 is a screen display of the graphical representation of the template tree that can be implemented within aspects of the present invention.

FIGS. 16A and 16B are screen displays of a tree representation with all relevant data of the final report entered as generated by aspects of the present invention.

FIG. 17 is a screen display of a report that can be generated within the present invention.

FIG. 18 is a flow diagram of a method for creating a template that can be used within aspects of the present invention.

FIG. 19 is a flow diagram of a method for generating a semantically rich, natural-language report that is implemented within aspects of the present invention.

### DETAIL DESCRIPTION

One or more exemplary embodiments of the invention are described below in detail. The disclosed embodiments are intended to be illustrative only since numerous modifications and variations therein will be apparent to those of ordinary skill in the art. In reference to the drawings, like numbers will indicate like parts continuously throughout the views.

Aspects of the present invention comprise a system for the generation of a grammatically appropriate natural-language text document based in part on information input by a user via at least one workstation that is configured for structured data entry. A grammatically appropriate natural text document is defined as a sentence, paragraph or other linguistic structure that is grammatically correct or sufficiently grammatically correct so as to be useful in the representation of information to a reviewer of the text.

The computer-implemented method of the present invention can be executed on a conventional personal computer workstation on which a web browser is displayed, wherein the computer workstation is connected to the Internet or to a local intranet, depending on the location of a central server. As well known in the art, a web browser is a software program that allows a user to receive and view hypertext documents that are transmitted from a server. A browser also allows a user to interact with the central server via ASP queries. Aspects of the present invention preferably implement data storage and processing operations on a central server. The computer can also include other hardware and software elements conventionally included in personal computers, such as a keyboard, a processor, a disk storage device such as a hard disk drive, input/output interfaces, a network interface, a removable read/write storage device such as a drive that uses a CD-ROM or floppy disk and a mouse.

The present invention provides for dynamically defining the structure of a template for the capture of data in a structured manner and thereafter generating reports containing information from the captured data. This important aspect of the present invention is accomplished through the implementation of dynamic user-interactive templates. Templates, as defined in the present invention, are a set of user interface data screens wherein each screen can comprise one or more terminal and non-terminal hierchy tree nodes. Further implemented within the templates are sentence templates, wherein sentence templates are system-user defined natural-language sentences that are embedded with content specific macros. A very important aspect of the present invention is that a system user has the capability to create and edit the hierchy tree nodes and the templates that allow the user to perform any predetermined data entry or data capturing task.

Within aspects of the present invention a template can comprise a set of graphical user interface (GUI) screens, wherein each screen comprises non-terminal and terminal nodes that are structured in a tree configuration. The terminal nodes of the interface are used as the actual data capture fields within aspects of the present invention. Each terminal node is also associated with a respective macro name. The data values that are entered at the nodes are identified as “findings” and are stored within the system in a findings/clinical data repository. At each non-terminal node there is defined a sentence that is embedded along with the macro names for the terminal nodes. There can be several levels of non-terminal nodes and accordingly sentences at each of these nodes are propagated to the topmost non-terminal node.

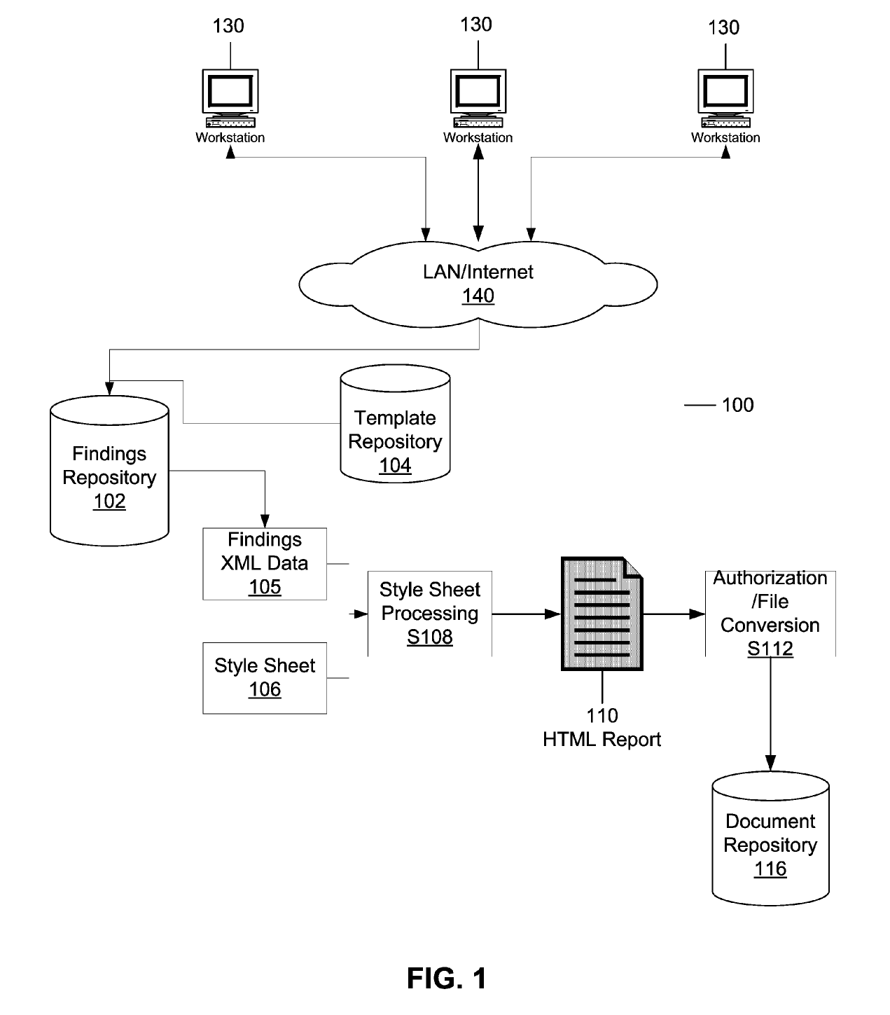

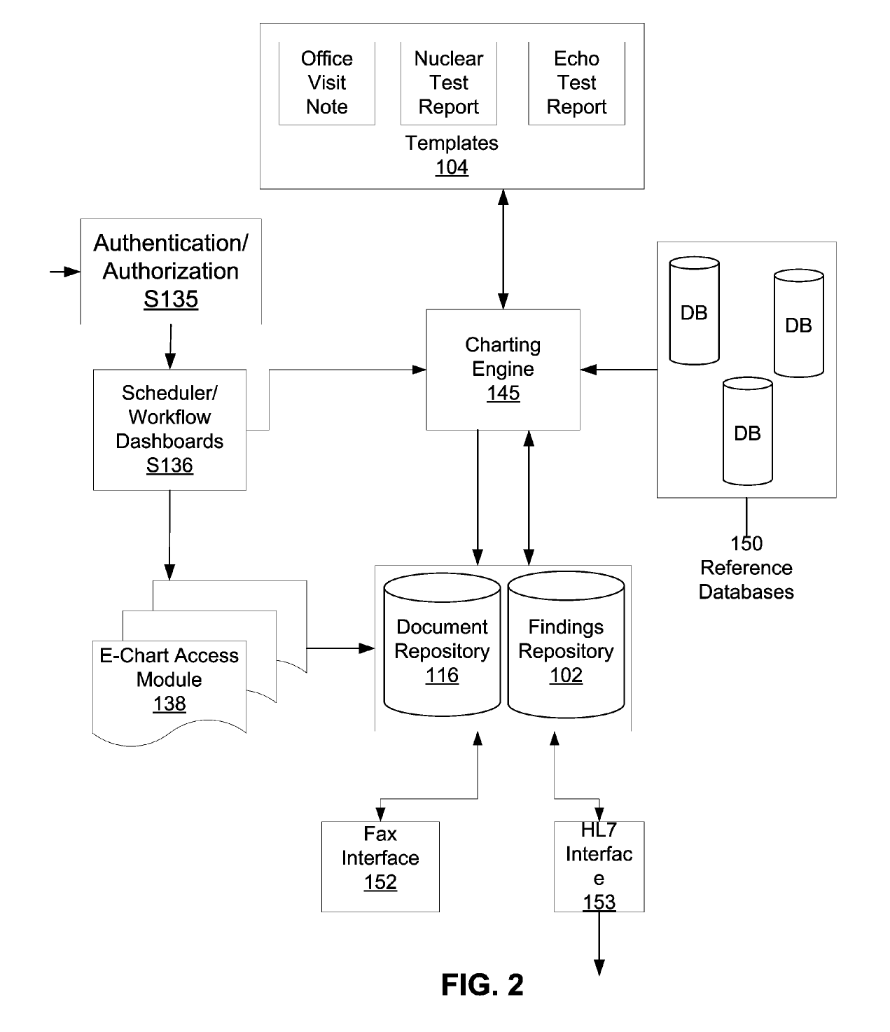

The present invention initially will be described in reference to FIGS. 1 and 2. As illustrated in FIG. 1, the present invention comprises a template-driven interaction system 100. As such, a system user can define one or more templates that capture the required data in a structured form via a LAN or the Internet 140, wherein the template is entirely customizable.

As illustrated in FIG. 1, within aspects of the present invention, a findings/clinical data repository 102 and document chart repository 116 are implemented to assist in the creation of semantically rich natural-language generated reports. Data that is captured by the system is stored in a findings/clinical data repository 102. The findings/clinical data repository 102 of the present invention is a persistent storage medium wherein captured findings and additional data are stored. This captured data is easily retrieved for later report generation, analysis and auditing.

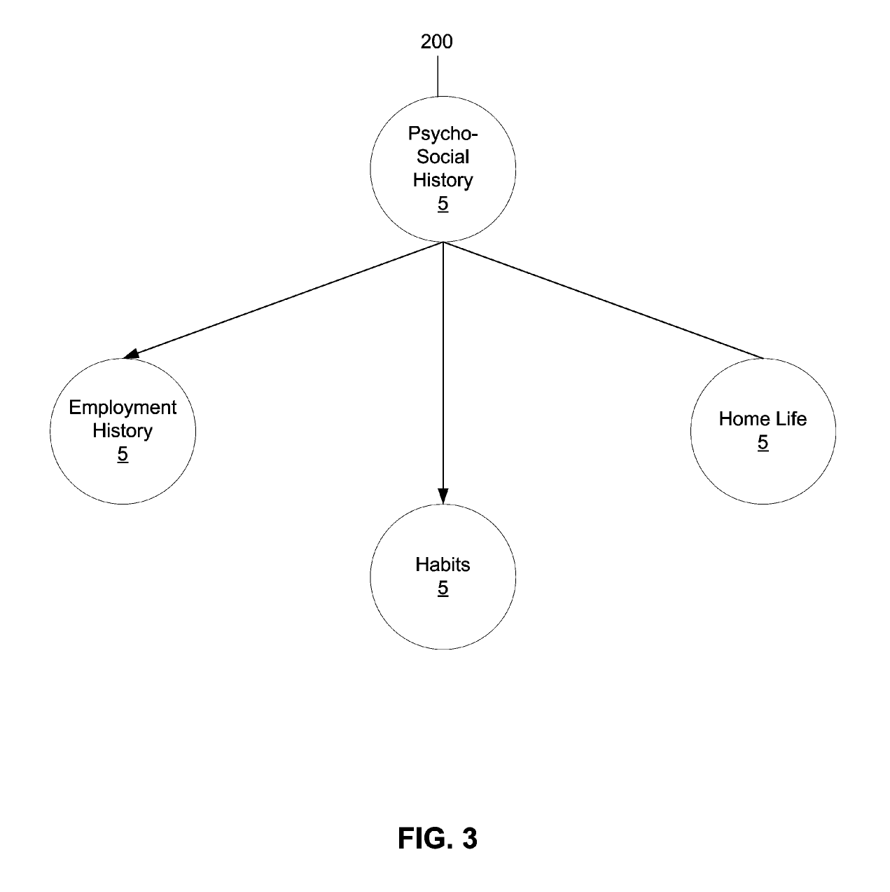

Raw data captured at each terminal node 20 is used to form meaningful sentences at the corresponding non-terminal node 5 levels (see FIGS. 3-6). The captured raw data and conceptual sentences are subsequently made available as XML data 106 to be further used within the system 100. The XML data 105 is processed at step 108 in conjunction with an appropriate XSL style sheet 106. Each template that is stored within the template repository 104 is customized to encompass a specific reporting format that a user may select when creating a new semantically rich, natural-language report. Further, each template that is stored within the template repository 104 comprised within the system 100 has its own customizable style sheet 106 that assists in the development of a customized reporting format and document layout. A fully customized HTML report 110 is thereafter automatically generated for the review of the system user.

Automatically generated reports 110 are transmitted and stored as documents within the document repository 116, where the documents are readily available for electronic distribution, viewing or printing. Reports that are properly accessed and authorized by system 100 users are converted to a predetermined file format at step 112. The authorized reports are automatically filed in the medical chart of a patient within the document chart repository 116, where the document is available for access. In the event that an authorized report is emailed to a referring physician or hospital, the system 100 provides for a log to be kept of the document transmission to the relevant party.

FIG. 2 illustrates an aspect wherein the functional aspects of the present invention are embodied as a remotely accesible charting engine that facilitates the generation of semantically rich natural-language reports. The charting engine 145 serves as the central dynamic sentence construction interface authority of the system 100. The charting engine 145 receives system user authentication/authorization (step 135) in addition to system scheduler and digital workflow dashboard input (step 136). The charting engine 145 also is in direct communication with the template repository 104, the findings repository 102, the document repository 116 and a plurality of reference databases 150.

A system 100 user accesses the system 100 via a workstation 130. Upon establishing a connection with the system 100 via a LAN or the Internet 140, the user will be required to perform a series of user authentication and authorization operations at step 135. Next, at step 136 the user specifies the specific reports that they desire to generate within the system 100 and subsequently is presented with an activity specified GUI via the operations of the charting engine 145.

Upon receiving the specified template request from the workflow dashboard generator, the charting engine 145 retrieves the required template data from the template repository 104 and forwards the template(s) to the workflow dashboard generator, wherein the workflow dashboard generator has the capability to dynamically present the data entry template GUI to a system user. In this instance the templates residing in the template repository 104 are specified for “Office Visit Note,” “Nuclear Test Report,” and “Echo Test Report.” As mentioned above, each template has the capability to comprise a set of GUI screens, wherein each screen comprises non-terminal and terminal nodes that are structured in a tree configuration. The terminal nodes of the interface are used as the actual data capture fields within aspects of the present invention.

User input data that is captured by the system is stored at the findings/clinical data repository 102. The captured data is easily accessed and retrieved for later report generation, analysis and auditing. The raw data captured at each terminal node 20 is used to form meaningful sentences at the corresponding non-terminal node 5 levels. A plurality of reference databases 150 may also be accessed by the charting engine 145, wherein the databases can be used to supply information to a semantically rich generated report. The content of the databases 150 may vary depending on the type of report that is to be generated and the field to which the report pertains. In this instance since a medical report is being generated a plurality of medically related databases will be embodied within the system 100 (e.g., databases containing information pertaining to drug monographs, drug formularies, specific drug interactions. local medical review board policies, etc. . . . ).

The captured raw data, conceptual sentences and reference database information is subsequently made available as XML data 106 to be further used within the system 100. The XML data 105 is processed at step 108 in conjunction with an appropriate XSL style sheet 106, wherein each template that is stored within the template repository 104 comprised within the system 100 has its own customizable style sheet that assists in the development of a customized reporting format and document layout. A fully customized HTML report 110 is thereafter automatically generated for the review of the system user.

Automatically generated reports 110 are stored by the charting engine 145 as documents within the document repository 116, where the documents are readily available for electronic distribution, viewing or printing. Reports that are properly accessed and authorized by system 100 via an electronic chart access module 138 are converted to a predetermined file format at step 112. The authorized reports are automatically filed in the medical chart of a patient within the document chart repository 116, where the document is available for access. The system 100 further comprises a Health Level 7 (HL7) interface 153, for the exchange of healthcare specific data between remote computer applications in addition to a fax interface 152. Electronic faxes that are transmitted by the system 100 or received by the system 100 can be transmitted to and stored within the document repository 116.

As illustrated in FIGS. 3-6, the structure for data capture is implemented as a tree whose terminal nodes 20 contain input data (e.g., such as text, Boolean, number, date, formula, selection or multi-selection).

The most frequently used values associated with a terminal node 20 can be dynamically added or removed. FIGS. 3-6 show a sample tree 200 that is used to capture the psycho-social history of a patient. The sub-tree consists of three non-terminal nodes 5, at level 2, the nodes being labeled “Home Life,” “Habits” and “Employment History.”

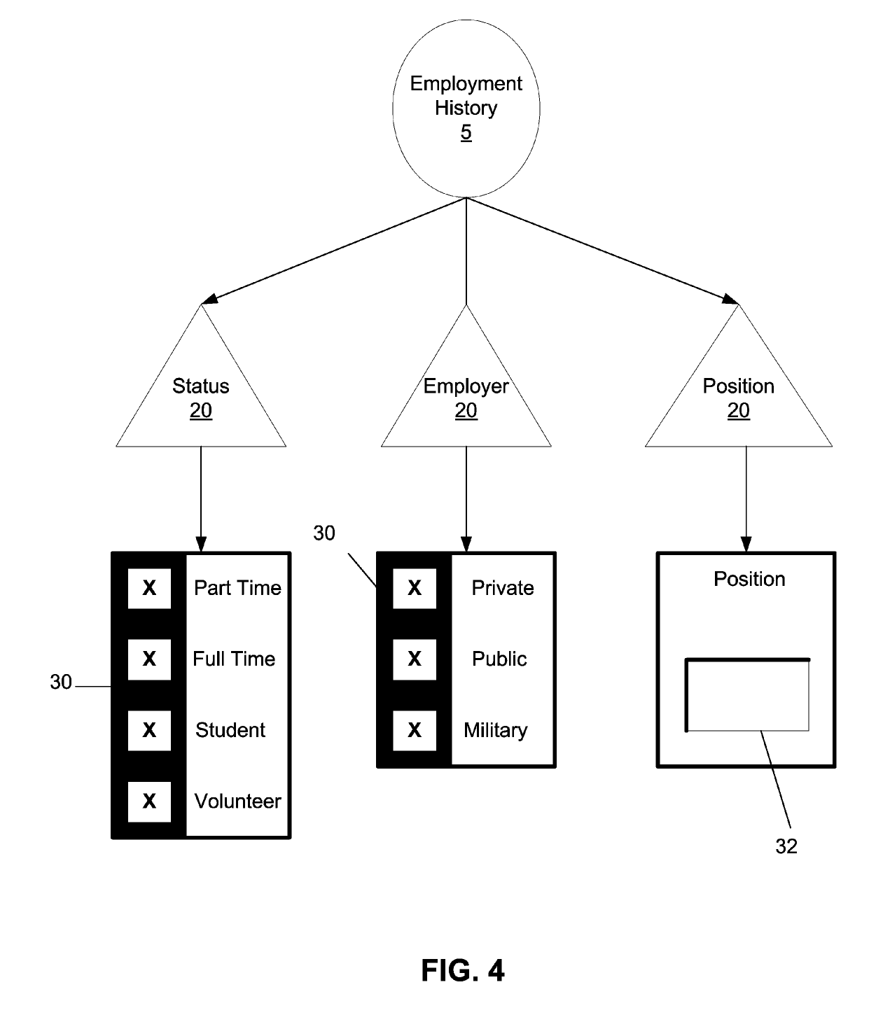

As seen in FIG. 4, the “Employment History” non-terminal node 5 comprises three terminal nodes 20 labled “Status,” “Employer” and “Position.” The terminal nodes 20 for “Status” and “Employer” comprise a selection box 30 for the selection of specific terms, while the node 20 for “Position” comprises a direct entry box 32 wherein a user may directly input data that is to be captured.

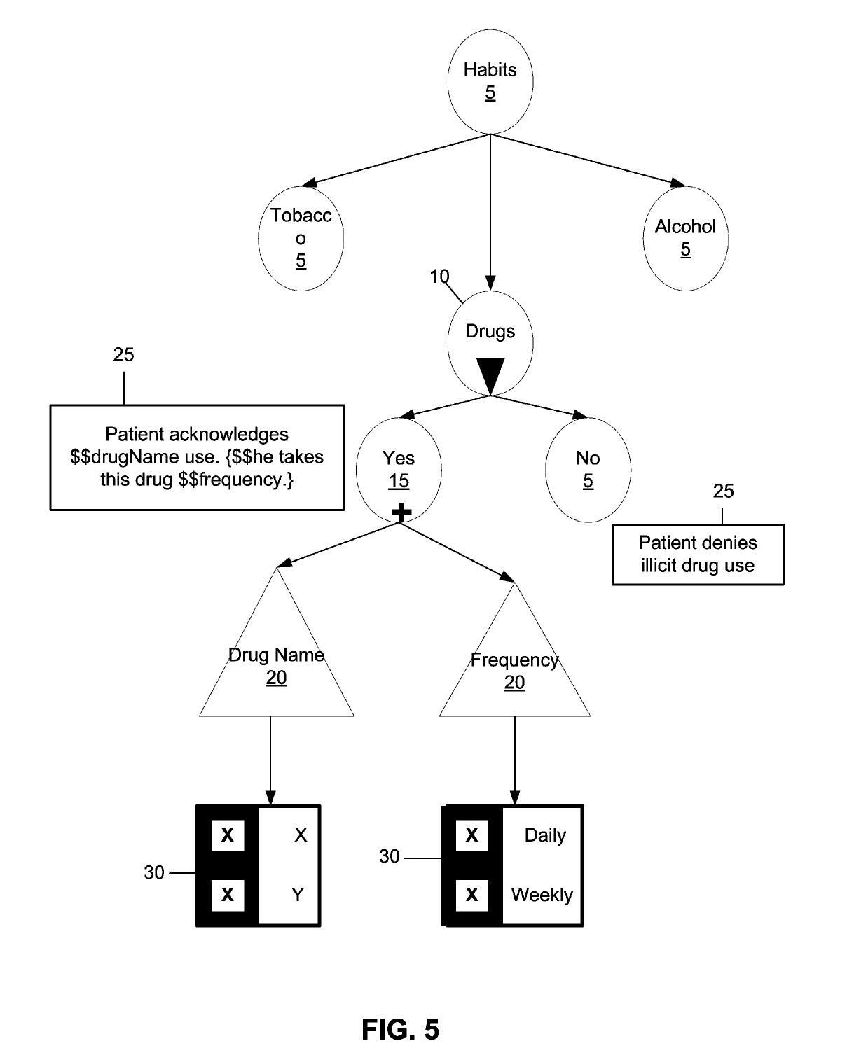

The “Habits” non-terminal node 5 (FIG. 5) further consists of three non-terminal nodes 5, “Tobacco,” “Drugs” and “Alcohol.” The “Drugs” non-terminal node 5 is a “selector” node 10 that consists of two nodes that correspond to two mutually exclusive paths labeled “Yes” and “No.” The “Yes” non-terminal node is a repeatable non-terminal node 15 that comprises two terminal nodes 20 labeled “Drug Name” and “Frequency.” The terminal node 20 “Drug Name” can comprise a multi-selection list box 30 and the terminal node 20 “Frequency” can be either an edit box or a selection list box 30 with various predefined options.

An added feature of the “Yes” non-terminal node 15 is the node's capability to have a multiplicity of more than one. For example, in the event wherein only one instance of a child node is displayed, a system user can select a repeat function wherein several instances of the repeatable non-terminal “Yes” node 15 can dynamically be created by the user for a respective template.

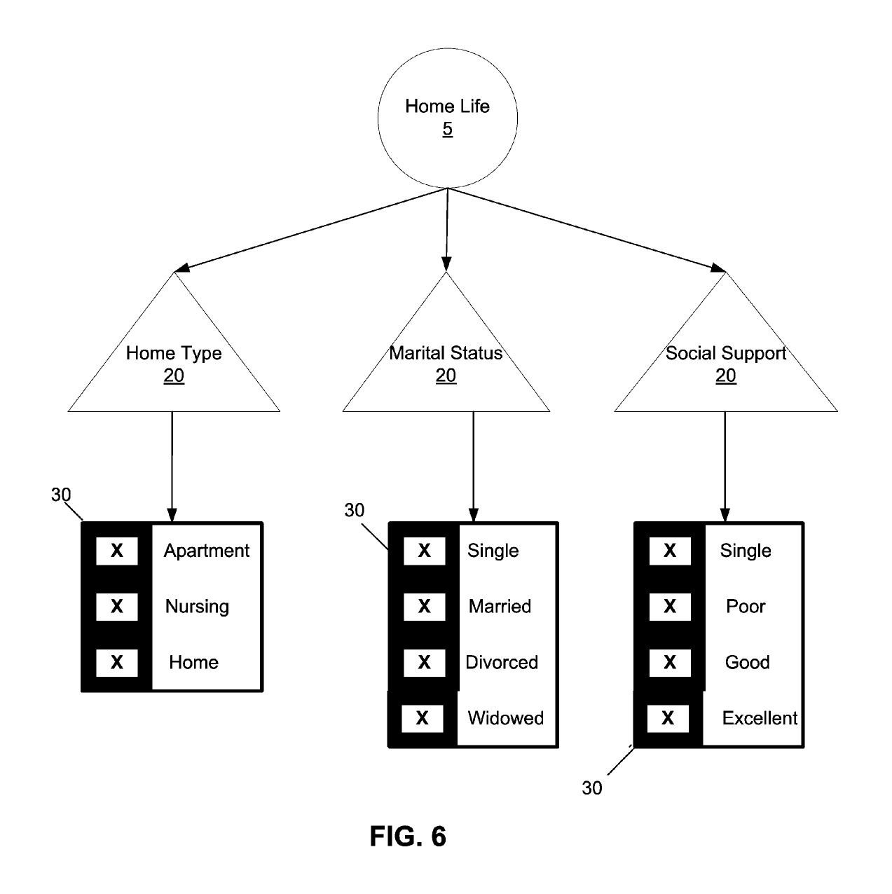

As shown in FIG. 6, the “Home Life” non-terminal node 5 comprises three terminal nodes 20 labled “Home Type,” “Marital Status” and “Social Support.” The terminal nodes 20 for the three terminal nodes 20 each comprise a selection box 30 for the selection of specific terms.

As mentioned above, a sentence template 25 is a user-defined sentence that is embedded with macros. In aspects of the present invention there are three types of templates 25 that are associated with each of the non-terminal nodes 5, 10. They are the “default” sentence template, the “non-default” sentence template and the formula template. A default sentence template is a system-user defined natural-language sentence that is comprised of a predetermined text string that is in the form of a sentence. A non-default sentence template is a system-user defined natural-language sentence comprising a predetermined text string and user input data or system-generated data. Aspects of the present invention use the information from a non-default sentence template to form a complete sentence. Also, a formula template can include a mathematical or logical formula which can perform operations on the macro values and present the results thereof.

The macro values of the sentence templates 25 correspond to a particular node, the macro values being substituted into the sentence template 25 by the actual data captured for that node. Selecting a “default” function for a particular node selects and implements a default sentence template 25. A “non-default” sentence template 25 is used in the event wherein data is actually entered into a field. Within further aspects of the present invention a user has the option to omit a node or an entire sub-tree, in which case the node values and sentences are ignored and not propagated up in the hierarchy.

For example, in FIG. 5, there is a default sentence associated with the “No” non-terminal node 5. In this instance, the default sentence states “Patient denies illicit drug use.” The non-default sentence associated with the “Yes” repeatable non-terminal node 15 is “Patient acknowledges $$DrugName use. {$$He takes this drug $$Frequency.}”. In this sentence template 25, $$DrugName is the macro for the terminal node 20 DrugName, $$Frequency is the macro for the terminal node 20 Frequency and $$He is a global macro that expands to the label “He” or “She” depending on the gender of a patient.

In further aspects of the present invention the sentence fragment enclosed in the brackets is optional in the event the “Frequency” terminal node 20 is not specified. In that instance, the optional sentence fragment is not included in the generated sentence. Additional aspects of the present invention allow for the implementation of several pre-defined global macros (e.g., the sex of a patient, date of birth, age, last name, first name, etc. . . . ), wherein the values of the macros are based on the patient's demographic information.

Within additional aspects of the present invention several rules govern the process for generating a sentence. In the event that a node does not have a directly defined sentence template 25, the node will inherit the sentences that have been generated by its immediate child nodes. For example, in the instance that there is a sentence template 25 that is associated with a node, then this sentence template 25 will be used for generating a sentence for this particular node. The sentence template 25 has correct structure and is embedded with global macros, in addition to macros that correspond to respective child nodes.

A node can also have a default sentence that comprises only global macros, wherein the default sentence is used in case the system user does not visit any of the child nodes associated with the node. In the instance that a node is omitted, the sentence associated with the node is not propagated. Additionally, at any level, the user can enter any other information that is not already captured in the templates by manually editing the sentence that has been generated. The manually edited sentence is then propagated to the parent non-terminal node 5. Further, editing a sentence does not change the underlying template. Within aspects of the present invention a user must use a template editor in order to change a template.

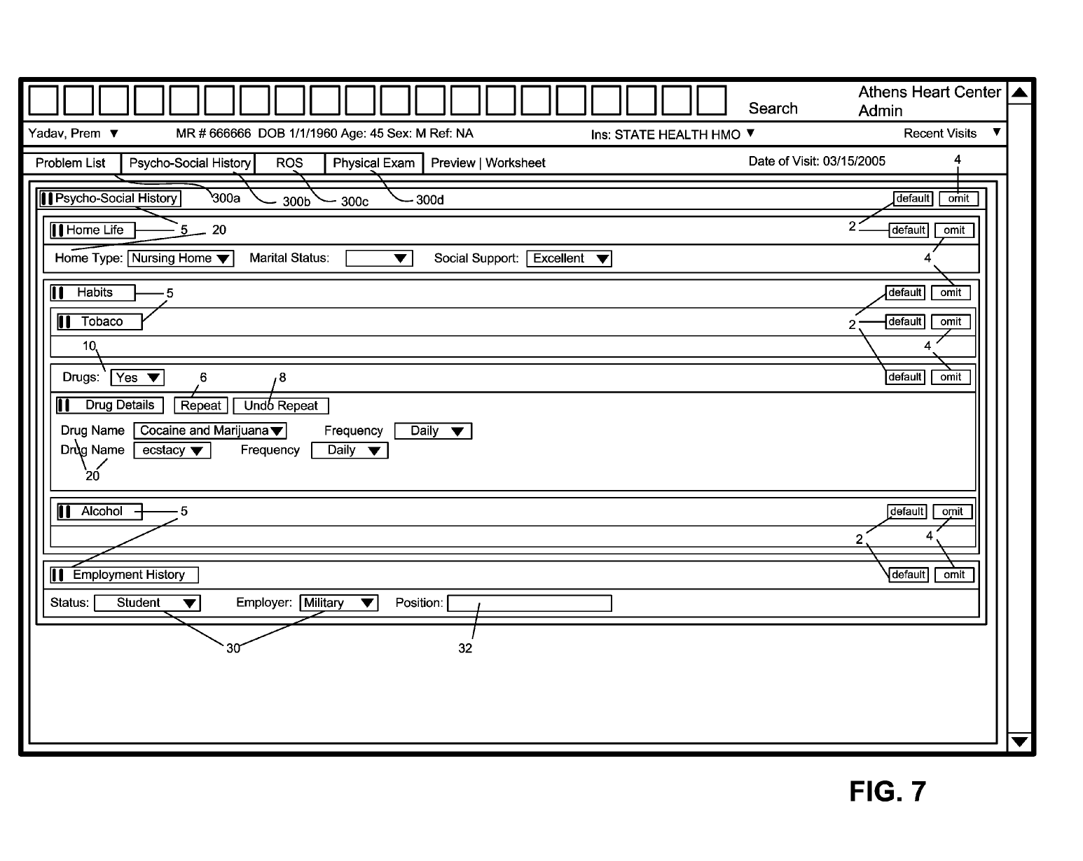

As illustrated in the screen displays of FIGS. 7-15, a template tree structure of the present invention can be represented on a display screen by constructing a webpage using DHTML within a web browser. Within aspects of the present invention a non-terminal node is graphically represented by a table with two rows; the first row being used to display a caption and the second row for displaying actual content that relates to the caption. Further, children non-terminal 5 nodes are nested within the content row of their parent non-terminal node. Yet further, children terminal nodes 20 are nested within the content row of their parent non-terminal node 5.

For the sake of simplicity, this tree, unlike conventionally used trees, is constrained so that a non-terminal node's immediate children must be either all non-terminal nodes or all terminal nodes. This means a parent content row cannot house a combination of terminal and non-terminal nodes. Additionally, a terminal node 20 can comprise a combination of a label and a GUI control (e.g., a check box, an edit box, or a selection list), also the terminal nodes 20 can be displayed in a flow, stack, or matrix layout.

As seen in FIGS. 7, 8 and 12-15, the GUI interface comprises a series of report category headings for report worksheets labeled “Problem List” 300a, “Psycho-Social History” 300b, “ROS” 300c and “Physical Exam” 300d. These headings may be selected by system 100 users to access the respective worksheet template tree for a report category.

A default button 2 and an omit button 4 are provided, wherein if a user selects a “default” function for a particular node the system 100 implements a default sentence template 25. Further, the omit button 4 provides a user with the capability to omit a node or an entire sub-tree, in which case the node values and sentences are ignored and not propagated up in the hierarchy. In the event that a non-terminal node 5 has a multiplicity of more than one, the caption row of the non-terminal node 5 will have a “Repeat” button 6 and an “Undo Repeat” button 8. Initially, only one instance of the child node is shown and the “Repeat” button 6 can be used to dynamically create another instance of the child node. If more than one instance of the repeater node exists, “Undo Repeat” 8 will remove the last repeated instance.

In aspects of the present invention, a “selector” non-terminal node 10 has a list box in the caption row with pre-defined, mutually exclusive options wherein each of these options is associated with a non-terminal node 5. Only the sub-tree associated with the selected option in the node is visible, while all other sub-trees are hidden. Additionally, non-terminal nodes 5 can have either a tabbed or normal layout. In a tabbed layout, these nodes can be selectively expanded or collapsed. Furthermore, each respective node can comprise an associated macro formula. A user-defined formula can be specified within aspects of the present invention for decision support operations or for the implementation of data validation logic.

A screen display that is used in conjunction within aspects of the present invention is shown in FIG. 7. FIG. 7 shows a screen shot that displays the template tree for capturing data related to the “Psycho-Social History” of a subject. As shown, the template displays the non-terminal node 5 headings for the “Home Life,” “Habits” and “Employment History” to capture data related to a subject's personal information (see FIG. 3).

Nested below the heading for the “Home Life” node 5 are terminal nodes 20 for the nodes for “Home Type,” “Marital Status” and “Social Support,” wherein the nodes each comprise a selection list box 30 displaying various predefined options (see FIG. 2D). Likewise, nested below the heading for the “Habits” node 5 are non-terminal nodes 5 for the nodes labeled “Tobacco” and “Alcohol.” A selector non-terminal node 10 is provided for the node labeled “Drugs,” wherein the node comprises two nodes that correspond to two mutually exclusive paths labeled “Yes” and “No,” the nodes comprising a “non-default” sentence template 25 and a “default” sentence template 25, respectively. The “Yes” repeatable node 15 yet further comprises two nested terminal nodes 20 for the nodes for “Drug Name” and “Frequency.”

The terminal nodes 20 “Drug Name” and the terminal node 20 “Frequency” comprise a selection list box 30 with various predefined options. Additionally, the “Yes” non-terminal node 15 can have a multiplicity of more than one. Initially, only one instance of this nested child node is displayed; however, by using a repeat function 6 several instances of the repeatable “Yes” node 15 can dynamically be created.

Nested below the non-terminal node 5 for “Employment History” are terminal nodes 20 for the headings “Status,” “Employer” and “Position” (see FIG. 4). The terminal nodes 20 for “Status” and “Employer” comprise a selection box 30 for the selection of specific terms, while the node 20 for “Position” comprises a direct entry box 32 wherein a user may directly input data that is to be captured.

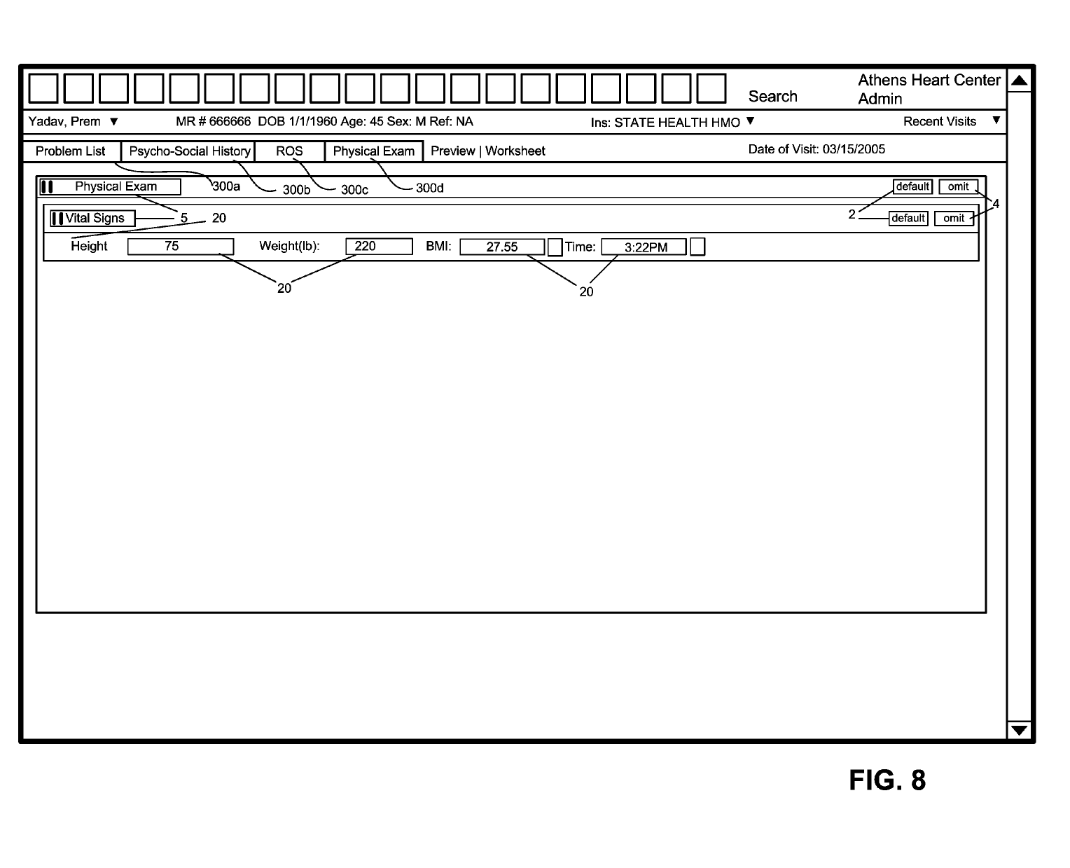

FIG. 8 is a screen shot displaying a screen for the “Vital Signs” capture node of the “Physical Exam” template tree, wherein a system calculated body mass index (bmi) and time-stamp value are displayed at respective terminal nodes 20. The capability to define a respective field and accordingly construct and assign input formulas that generate values for the respective fields is an important aspect of the present invention. By giving a user the capability to specifically configure and customize a GUI interface, the capacity of a user to capture important and relevant data is greatly increased.

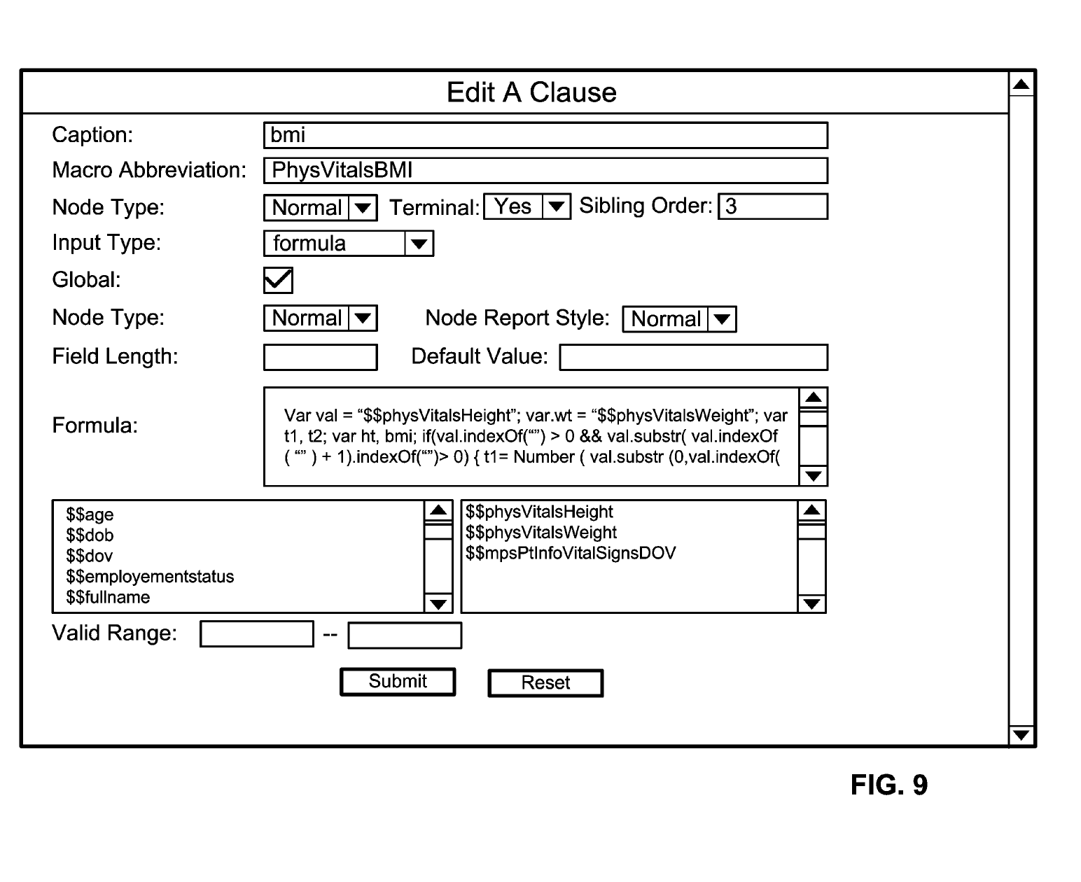

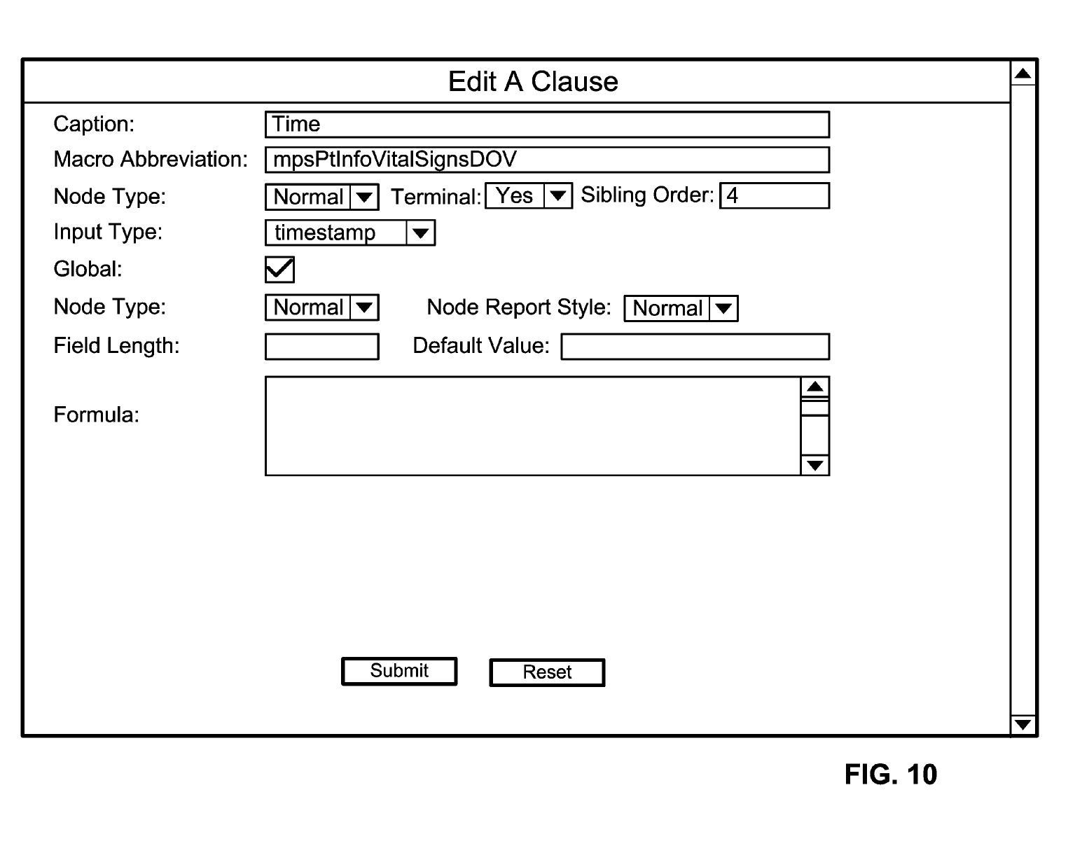

FIGS. 9-11 are screen shots of examples of editing screens for entering data or formulas in regard to terminal 20 and non-terminal nodes 5. FIG. 9 is a screen shot that shows the attributes of a formula type terminal node, in this instance the a screen shot shows the details of a formula that has been entered at a particular node, in this example the node is the bmi node as shown in FIG. 8. In this instance, the data entered at the nodes for “Height” and “Weight” is used at the “bmi” node to calculate the bmi value. Here the script for calculating the value of “bmi” based upon the values of Height and Weight is specified. FIG. 10 additionally shows a screen shot that shows the details of an editing screen for the entering of a timestamp in a respective terminal node field. In this instance, the timestamp value is configured for display at a “Time” node, as shown in FIG. 8.

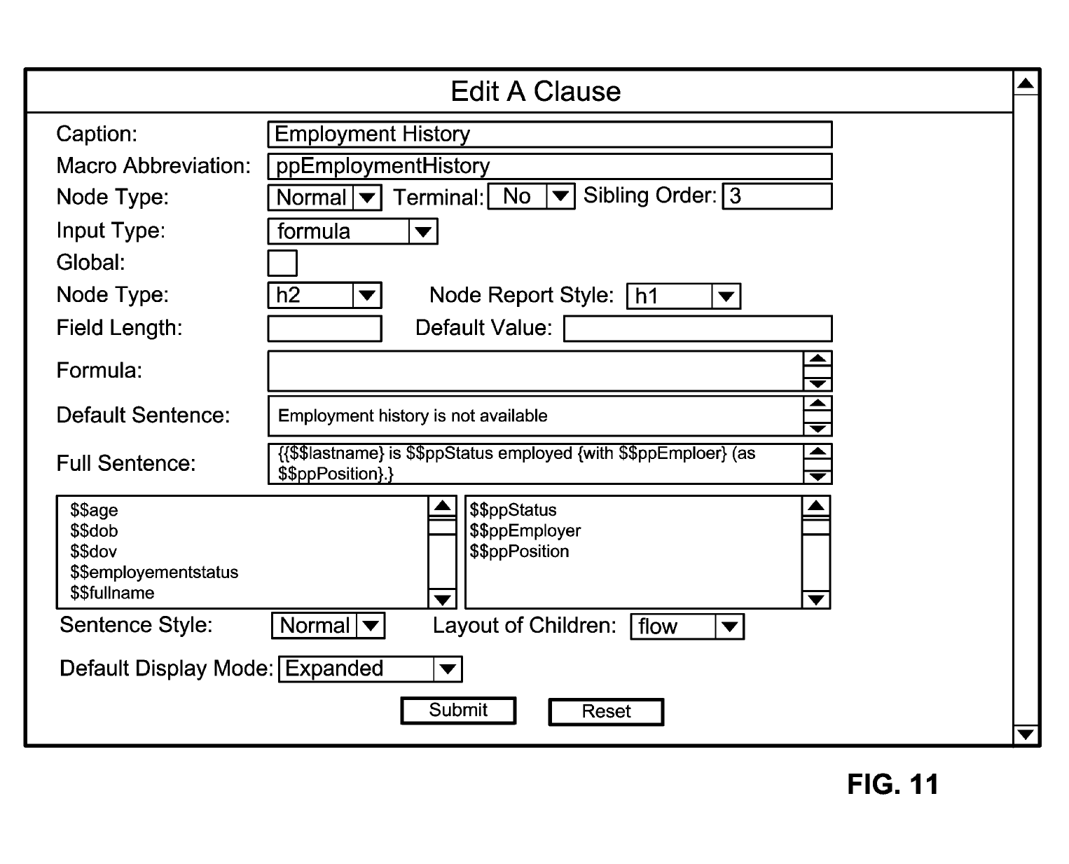

Similarly, FIG. 11 is a screen shot of an editing screen for a non-terminal node 5, in this instance the non-terminal node 5 is the node for the “Employment History” node of the “Psycho-Social History” tree (FIG. 4). In this instance, a default sentence is provided as a data option in addition to a non-default sentence wherein data from the terminal nodes 20 “Status,” “Employer” and “Position” are captured and populated into the non-default sentence.

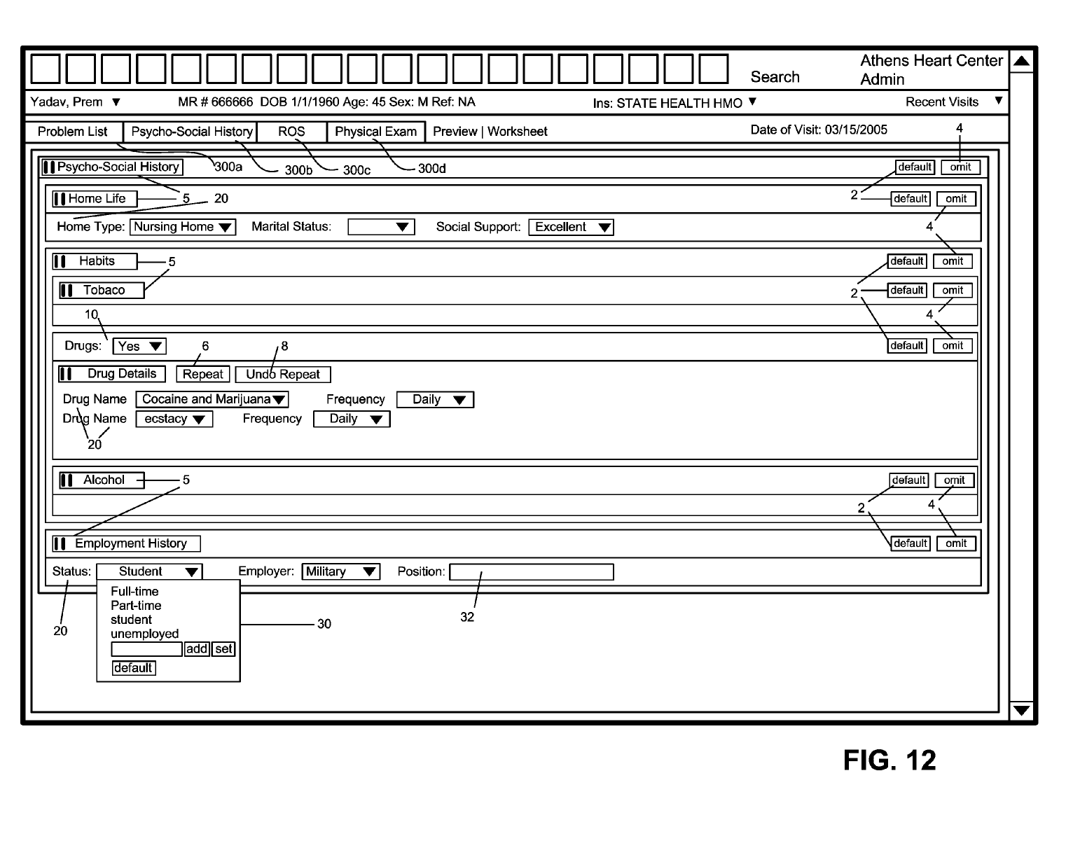

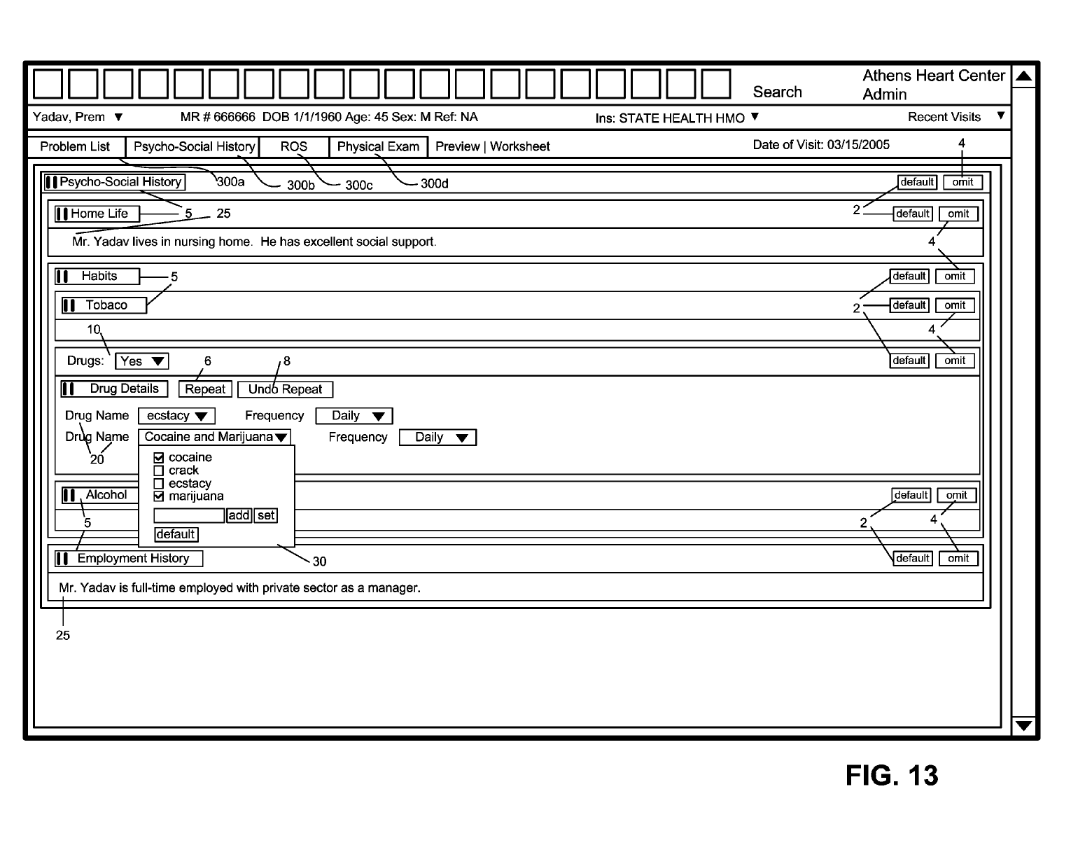

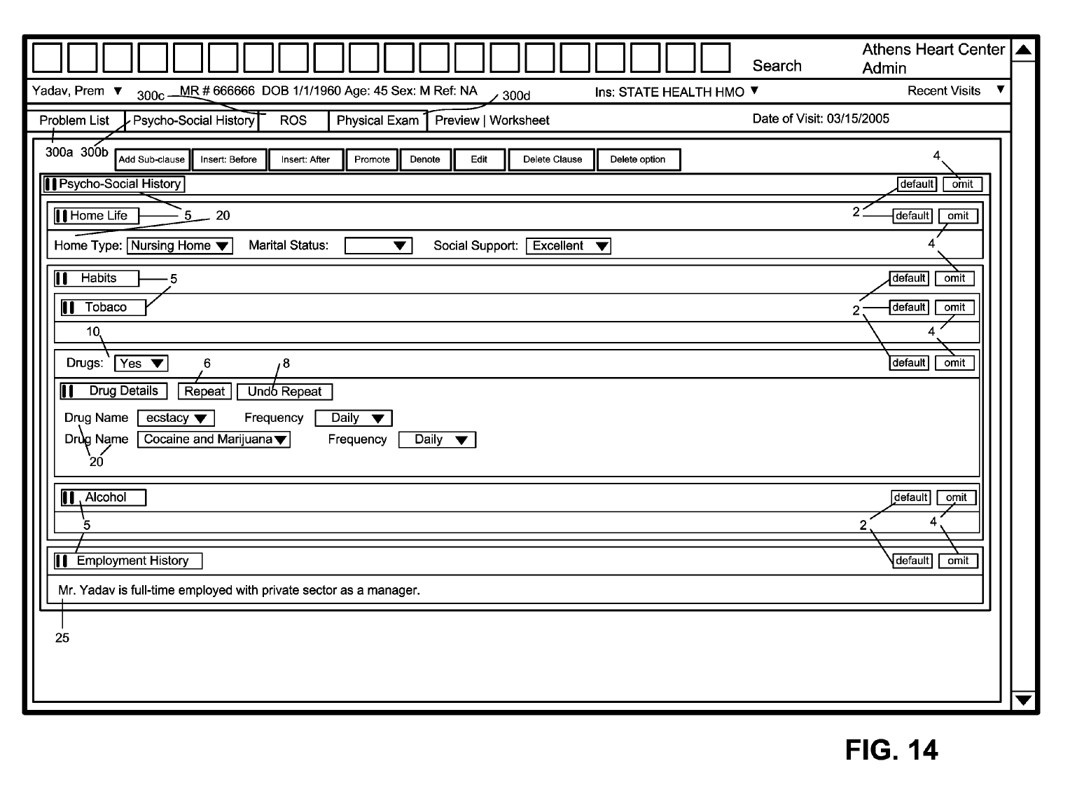

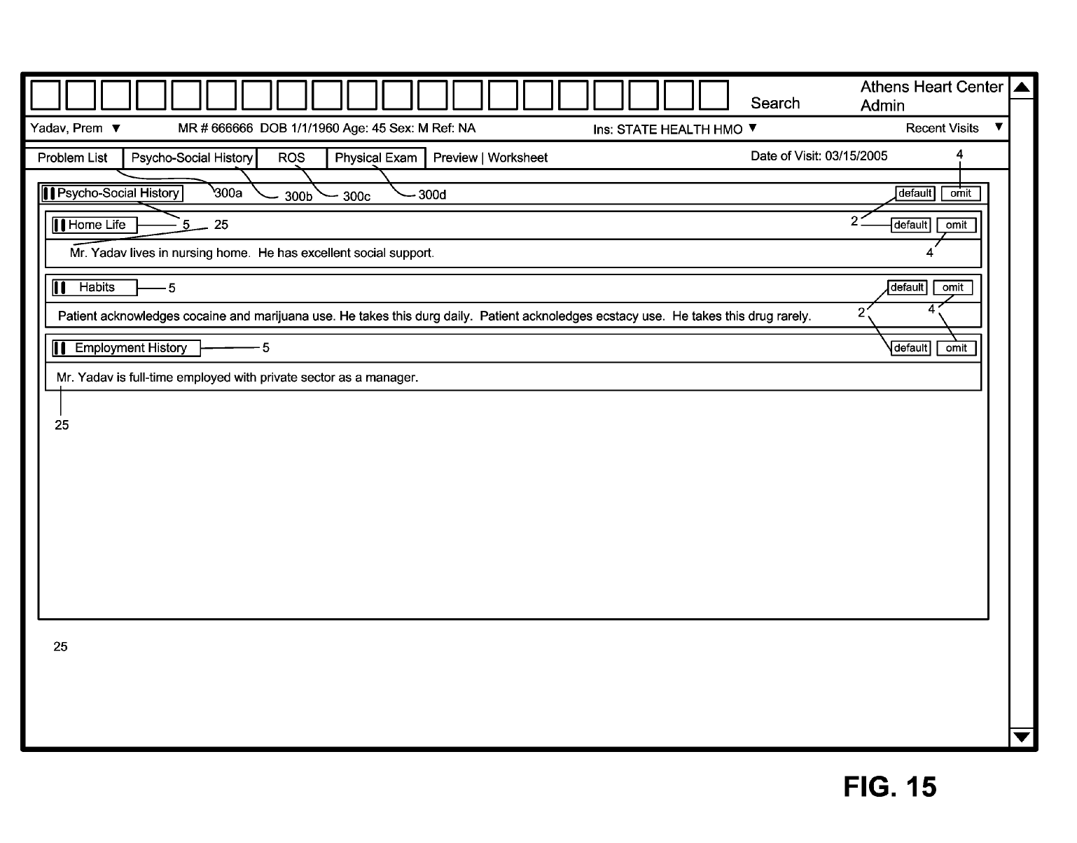

FIGS. 12 and 13 show screen shots wherein drop-down selection tables are displayed at the selector type non-terminal node 10 for the “Drugs” and “Yes” branch and the terminal node 20 for the “Employment History” and “Status” branch, respectively. The choices in the drop-selection tables can be modified by the user or overridden by the user. FIG. 14 shows a screen shot wherein the final generated sentence from the non-default sentence at the “Employment History” non-terminal node 5 is displayed. The generated sentence of FIG. 14 is the result of the captured data being used in conjunction with the non-default sentence to generate a semantically rich natural-language sentence within aspects of the present invention. Further examples of sentences that have been generated at the non-terminal nodes 5 of the “Home Life,” “Habits” and “Employment History” branches of the “Psycho-Social History” template tree are shown in FIG. 15.

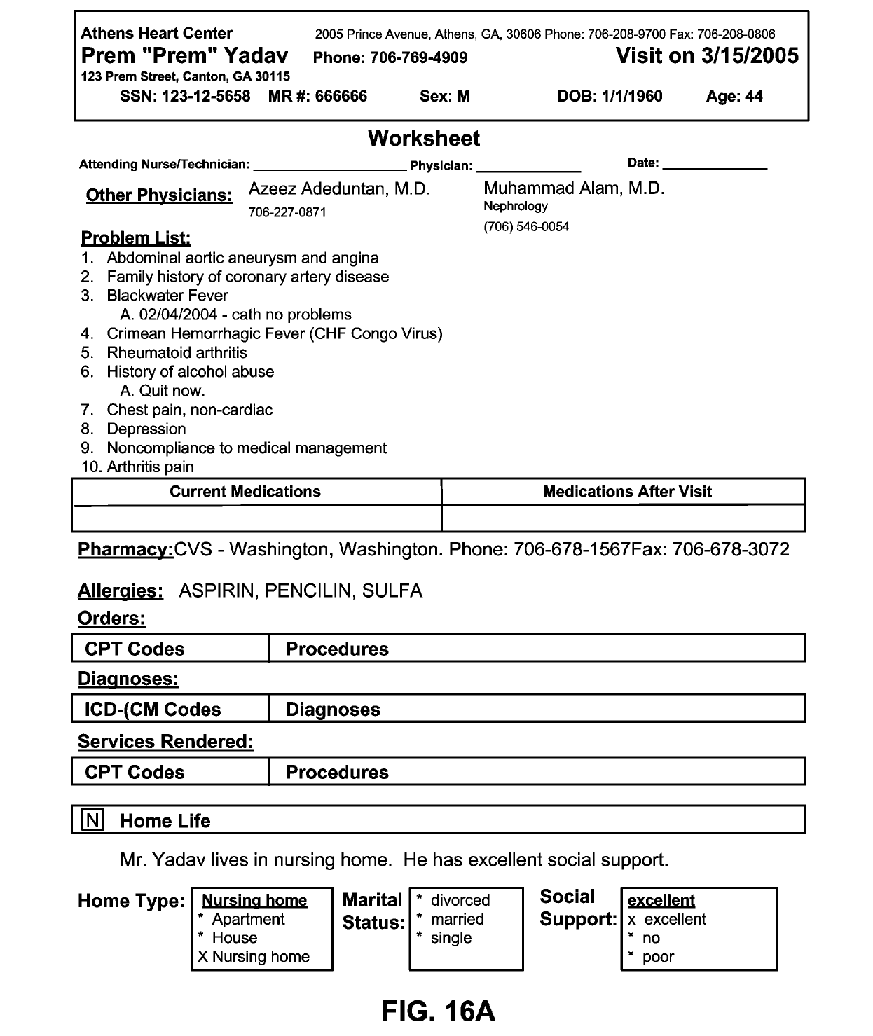

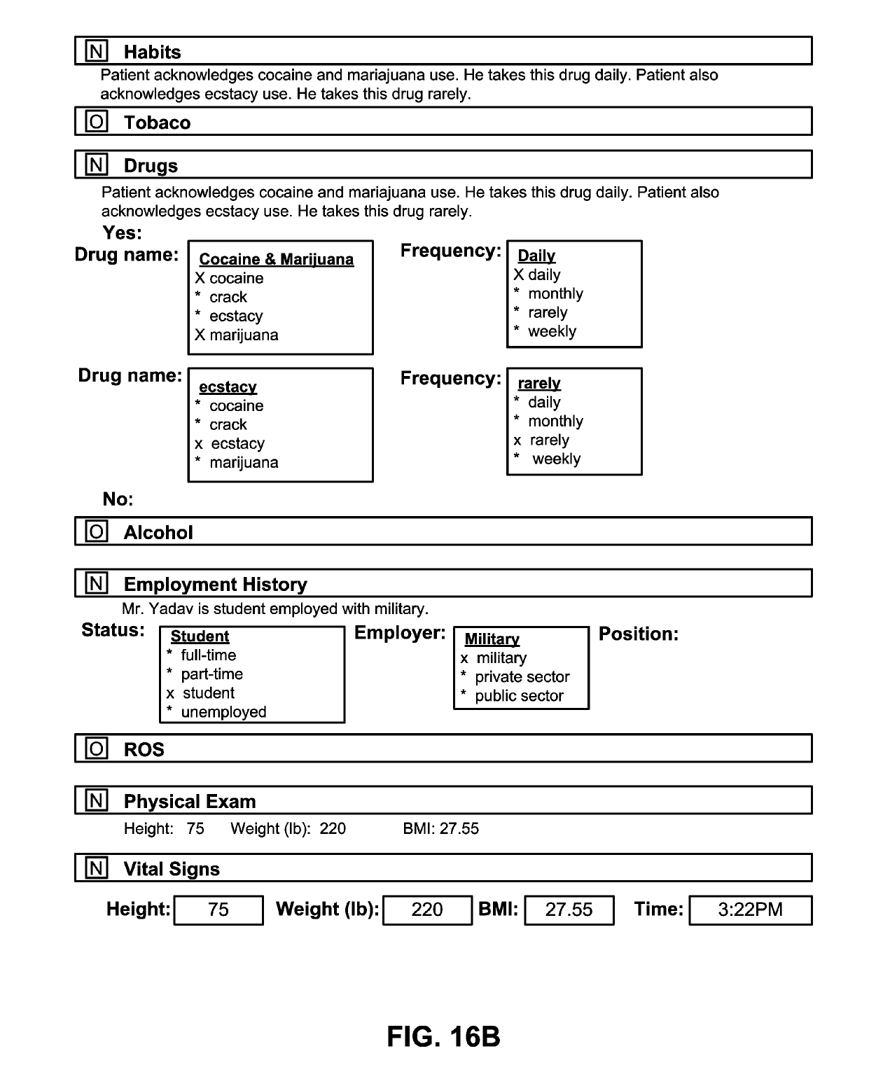

FIGS. 16A and 16B show a view of a semantically rich, natural language report screen that is generated within aspects of the present invention, wherein the report is viewed in conjunction with all the captured data and sentences that have been generated utilizing the captured data. A system 100 user views the GUI, and as shown n FIGS. 16A and 16B is presented with a plurality of data capture fields wherein the user can select the data that will be assimilated into the final stylized report.

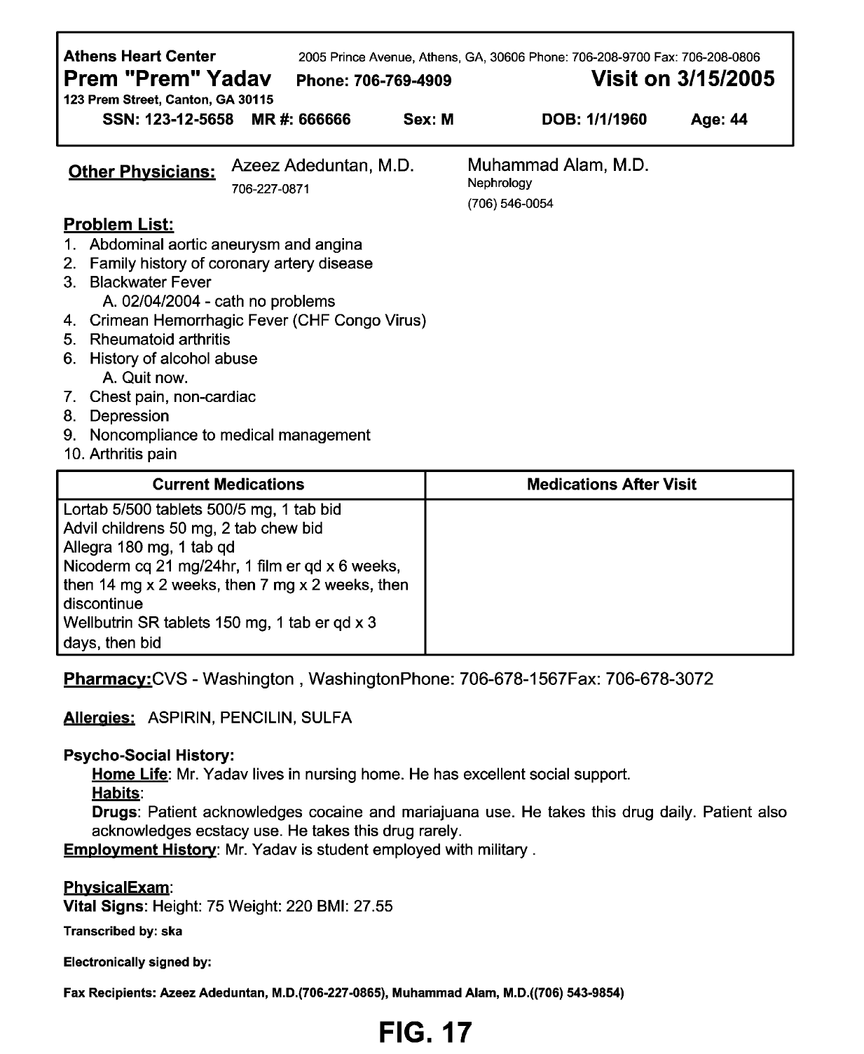

FIG. 17 shows a final semantically rich customized natural-language report that is generated and displayed to a system user on a display device within aspects of the present invention. As shown, the final stylized report seamlessly integrates the captured data that has been entered by a system 100 user, and subsequently presents the captured data in an easily accessible and legible reporting format.

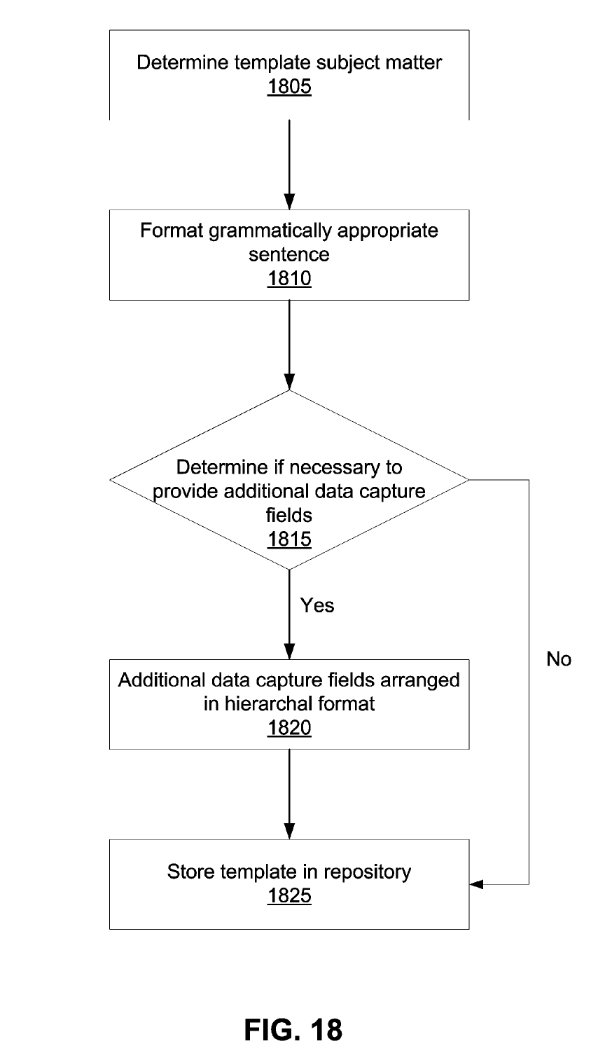

FIG. 18 shows a flow diagram of a method for creating a template that can be used within aspects of the present invention. At step 1805 the subject matter of the template is ascertained and thereafter, at step 1810 at least one natural-language sentence is formatted in a grammatically appropriate structure. The grammatically appropriate structure preferably has a plurality of predetermined word locations, wherein the word locations are populated with predetermined words for a sentence. Also, at least one variable data capture field is provided for receiving information provided by a user in a data entry operation.

Next, at step 1815, a determination of whether to obtain additional information from the user is provided within aspects of the constructed template. The determination is accomplished by enabling the template to display at least one second data capture field that in association with prompting information for prompting the user as to what information should be provided in the second data capture field. The second data capture field and associated prompting information are configured for display to the user in a hierarchically arranged format on the workstation 130. This visual hierarchal aspect allows the user to visually ascertain a parent/child or nested relationships between the first data capture field and associated prompting information and the second data capture field and associated prompting information. Lastly, the customized template is stored at the template repository 104.

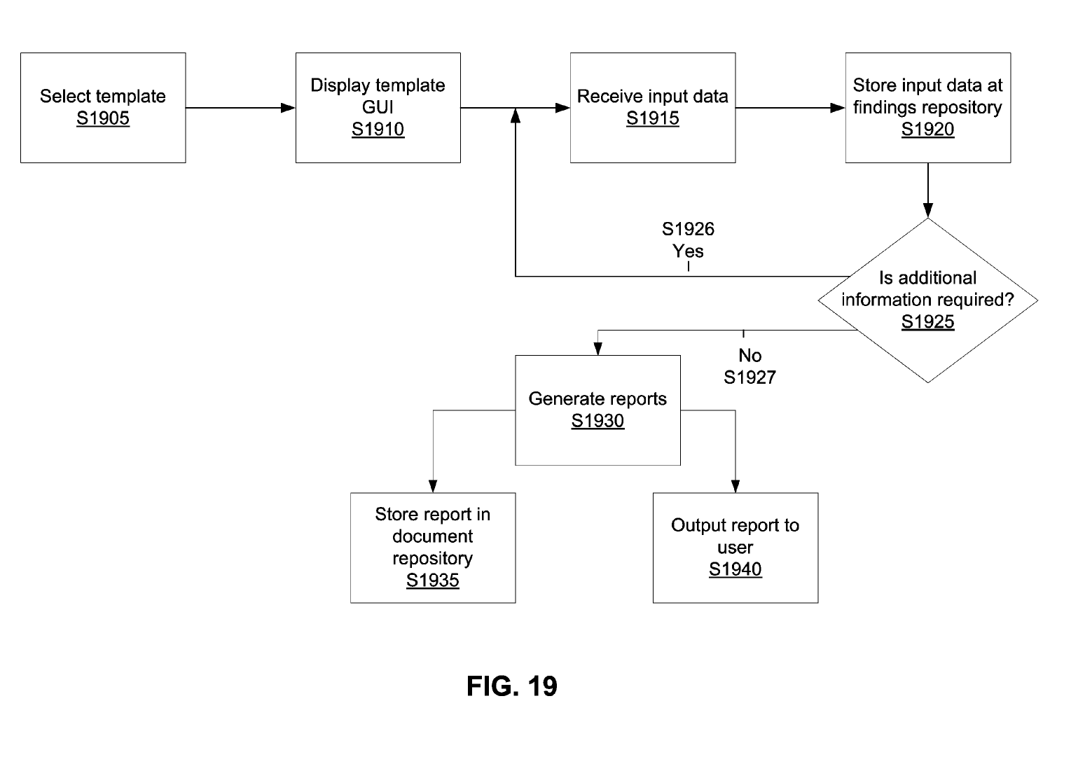

FIG. 19 shows a method for generating a semantically rich, natural-language report that is implemented within aspects of the present invention. At step 1905, a system 100 user selects a template that is to be used to construct a report. A GUI of the template is displayed to the user at step 1910. At step 1915, the user inputs data into the data input areas of the GUI in response to the user-prompts that are displayed by the report template GUI. The data that is input by the user is thereafter saved to the findings repository 102 at step 1920. At step 1925, the user makes the determination as to whether additional information is to be entered at the template GUI.

In the event that additional information is required, at step 1926 at least one second data capture field is displayed in association with prompting information for prompting the user as to what information should be provided in the second data capture field. The second data capture field and associated prompting information are configured for display to the user in a hierarchically arranged format (parent/child or nested relationship) on the workstation 130. In the instance that no additional data is required, then at step 1927 the system proceeds to generate a report at step 1930. The generated report is stored within the document repository (step 1935) and output to the user at a workstation 130 display device for the user to review (step 1940).

A yet another aspect of the present invention comprises a method for the generation of a grammatically appropriate natural-language text document based in part on information input by a user via at least one workstation configured for structured data entry. The method comprises the steps of providing at least one workstation for presenting information to a user and for receiving data input by the user via an associated data entry device and providing a findings repository 102 for storing information input by the user. Further, the method provides a template repository 104 for storing at least one natural-language sentence template preformatted in a grammatically appropriate structure having a plurality of predetermined word locations populated with predetermined words for a sentence and at least one variable data capture field for receiving information provided by the user in a data entry operation.

A document repository 116 is provided for the storage of text documents that have been generated in the method. Additionally, on the workstation 130, a user interface is displayed comprising at least one first data capture field in association with prompting information for the prompting of a user as to what information should be provided in the first data capture field. In response to input by the user of particular first information in the first data capture field, storing the particular first information in a data record in the findings repository 102 and associating the particular first information with a corresponding variable data capture field in a natural-language sentence template.

Further, response to input by the user of particular first information in the first data capture field, obtaining additional information from the user by displaying at least one second data capture field in association with prompting information for prompting the user as to what information should be provided in the second data capture field. Also, in response to input by the user of particular second information in the second data capture field, storing the particular second information in a data record in the findings repository 102 and associating the particular second information with a corresponding variable data field in a natural-language sentence template.

A text document is generated by retrieving data records of information input by a user and inserting retrieved data into a plurality of grammatically appropriate sentences arranged in a predetermined format. Lastly, the text document is stored within the document repository 116 and provided as a report output.

A further aspect of the present invention comprises a computer-implemented method for generating a natural-language written document based on information input by a user in response to computer-assisted querying. The computer-implemented method provides the means for the user to create logical trees and sentence templates that are used as indicated herein. The computer-implemented method comprises the steps of storing a plurality of information queries arranged in a logical tree having non-terminal nodes and terminal nodes. It further comprises the information queries including data input controls for receiving user data input and displaying at least one non-terminal information query associated with a non-terminal node of the tree. The non-terminal information query comprises of a table having at least two rows. The first row of the table has a caption and the second row of the table has a content area associated with the caption.

Further, the method provides for displaying a first related non-terminal information query associated with a non-terminal node of the tree as nested within the content area of the content row, for displaying additional related terminal information queries associated with terminal nodes of the tree as nested within the content area of the content row, and for the receiving of user data input by the data input controls in response to the displaying steps. In response to user input of particular information a determination is made whether a related additional question is applicable or that a terminal node has been reached, further repeating the above steps until a terminal node is reached.

In response to reaching a terminal node 20, storing data from user input of information in a findings repository 102 and upon reaching a final terminal node 20 of the logical tree, generating a document. The document is generated by the steps of retrieving a predetermined sentence template containing predetermined portions of a natural-language sentence or other grammatical structure, having embedded macros for receiving particular information stored in the findings repository 102 and populating data fields in the template and retrieving information corresponding to the embedded macros from the findings repository 102. Further, the data fields are populated in the template so as to provide a grammatically appropriate structure for a sentence and a plurality of completed natural-language sentence are stored as a part of a document in a document repository 116.

A further aspect of the present invention comprises a computer-implemented method for generating a natural-language written document based on information input by a user in response to computer-assisted querying. The computer-implemented method comprises the steps of storing a plurality of information queries arranged in a logical tree having non-terminal nodes 5, 10 and terminal nodes 20, the information queries including data input controls for receiving user data input and displaying at least one non-terminal information query associated with a non-terminal node 5, 10 of the tree, the at least one non-terminal information query comprising a table having at least two rows, a first row of the table having a caption and a second content row of the table comprising a content area associated with the caption.

The method also provides for displaying a first related non-terminal information query associated with a non-terminal node 5, 10 of the tree as nested within the content area of the content row, displaying a second related terminal information query associated with a terminal node of the tree as nested within the content area of the content row, receiving user data input by the data input controls in response to the displaying steps.

Additionally, the method provides for constructing a natural-language sentence for each non-terminal node 5, 10 of the tree as a function of user input, utilizing predetermined information from a pre-stored sentence template associated with the non-terminal node 5, 10 and information input by the data input controls associated with nodes of the logical tree; and providing a natural-language written document as an output assembled from a plurality of natural-language sentences generated in sentence constructing step.

A yet further aspect of the present invention comprises a method for generating a natural-language written document based on information input by a user in response to computer-assisted querying. The method comprises the steps of providing a structured data entry display containing a plurality of hierarchically arranged information queries, with related terminal information queries being displayed in a nested association with a non-terminal information query, the information queries comprising data input controls for receiving user data input and storing a plurality of sentence templates for generating natural-language sentences based in part on predetermined sentence structural information and in part on information provided by user data input in response to the information queries.

Further, the method provides for storing information from user data input provided in response to the information queries in a findings repository 102 and merging information from the findings repository 102 into the sentence templates to generate a preliminary data file comprising a plurality of natural-language sentences. Lastly, the preliminary data file is converted into a word processing document in a predetermined word processing file format and the word processing document is thereafter stored in a document repository 116.

A yet another aspect of the present invention comprises a system for generating a grammatically appropriate natural-language text document based in part on information input by a user during a structured data entry session. The system comprises at least one workstation for presenting information to a user and for receiving data input by the user via an associated data entry device and a findings repository for storing information input by the user. Further, a template repository 104 is comprised for storing at least one natural-language sentence template preformatted in a grammatically appropriate structure representing natural-language sentences based in part on predetermined sentence structural information and in part on information provided by user data input in response to information queries.

The system comprises a document repository 116 for storing generated text documents and a computer processor operative for generating a structured data entry display at a workstation 130, the display comprising a plurality of hierarchically arranged information queries, with a terminal information query being displayed in a nested association with a non-terminal information query, the information queries including data input controls for receiving user data input from a data entry device. The computer processor further stores information from user data input provided in response to the information queries in the findings repository and merges the information from the findings repository 102 into the sentence templates to generate a preliminary data file comprising a plurality of natural-language sentences. Further, the preliminary data file is converted into a word processing document in a predetermined word processing file format and the word processing document is stored in the document repository 116.

Therefore, it will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for generating a grammatically appropriate natural-language text document based in part on information input by a user via at least one workstation configured for structured data entry, comprising the steps of:
(a) providing at least one workstation for presenting information to a user and for receiving data input by the user via an associated data entry device;
(b) providing a findings repository for storing information input by the user;
(c) providing a template repository for storing at least one natural-language sentence template preformatted in a grammatically appropriate structure having a plurality of predetermined word locations populated with predetermined words for a sentence and at least one variable data capture field for receiving information provided by the user in a data entry operation;
(d) providing a document repository for storing text documents generated in the method;
(e) on the workstation, displaying a user interface comprising at least one first data capture field in association with prompting information for prompting the user as to what information should be provided in the first data capture field;
(f) in response to input by the user of particular first information in the first data capture field, storing the particular first information in a data record in the findings repository and associating the particular first information with a corresponding variable data capture field in a natural-language sentence template;
(g) in further response to input by the user of particular first information in the first data capture field, determining whether to obtain additional information from the user by displaying at least one second data capture field in association with prompting information for prompting the user as to what information should be provided in the second data capture field;
(h) in response to input by the user of particular second information in the second data capture field, storing the particular second information in a data record in the findings repository and associating the particular second information with a corresponding variable data field in a natural-language sentence template;
(i) generating a text document by retrieving data records of information input by a user and inserting retrieved data into a plurality of grammatically appropriate sentences arranged in a predetermined format;
(j) storing the text document in the document repository; and
(k) providing the text document as a report output.

2. The method of claim 1, wherein the findings repository, the document repository, and the template repository are made available to the workstation.

3. The method of claim 1, wherein the findings repository, the document repository, and the template repository are stored at a central server.

4. The method of claim 1, wherein the workstation is connected to the central server for operations via a web-styled interface.

5. The method of claim 1, wherein the grammatically appropriate structure comprises a natural-language syntax including grammar and punctuation.

6. The method of claim 1, wherein the second data capture field and associated prompting information is displayed to the user in a hierarchically arranged format on the workstation so that the user can visually ascertain a parent/child or nested relationship between the first data capture field and associated prompting information and the second data capture field and associated prompting information.

7. The method of claim 6, wherein the hierarchy is constrained so that a non-terminal node's immediate children must be either all non-terminal nodes or all terminal nodes.

8. The method of claim 1, wherein the step of determining whether to obtain additional information from the user by displaying at least one second data capture field in association with prompting information comprises traversing the branches of a decision tree to a non-terminal node of the tree as a function of the particular first information.

9. The method of claim 8, where in the event a non-terminal node is designated a repeater node, the non-terminal node will upon user request dynamically replicate itself, complete with children, in order to allow the capture of multiple occurrences of similar data.

10. The method of claim 8, where in the event a non-terminal node is designated a selector node the non-terminal node will dynamically present different tree paths to the user depending upon the data entered.

11. The method of claim 1, wherein the step of storing the particular first information in a data record comprises inserting the particular first information from the first data capture field into a data record associated with a sentence template from the template repository and storing the combined information in a sentence during the document generating step.

12. The method of claim 1, wherein the step of storing the data record of the particular second information comprises inserting the particular second information from the second data capture field into previously identified data record associated with a previously and partially completed sentence template having particular first information input by the user.

13. The method of claim 12, wherein an element of the sentence can be configured to be optional and in the event that no data is input for the element, the element will be omitted.

14. Further, the method of claim 12, wherein an optional element may be nested within other optional elements thus allowing for the construction of complex sentences that can be varied according to the data is entered.

15. The method of claim 1, wherein the step of providing the text document as a report output comprises displaying a report, printing a report, or communicating the report to another user and/or workstation.

16. The method of claim 1, further comprising the step of providing information from the findings repository in response to a findings query.

17. The method of claim 1, wherein the user creates logical trees, the logical trees comprising sentence templates at its non-terminal nodes and data capture fields as terminal nodes.

18. The method of claim 17, wherein a structured data entry screen template consists of one or more logical trees that are configured to capture structured data and generate natural-language sentences according to a set of predetermined rules.

19. The method of claim 18, wherein the logical tree nodes have local or global attributes that can be accessed through local or global macros, the scope of a local macro being limited to the logical tree where it is defined and global macros are available to all templates.

20. The method of claim 18, wherein a node can be a terminal node that includes at least one data capture field or a non-terminal node that includes at least one child node.

21. The method of claim 18, wherein the sentence generating rules include a rule that if a node does not have an associated sentence template, that node inherits sentences generated by a child node.

22. The method of claim 18, wherein the sentence generating rules include a rule that if a node has an associated sentence template, that node uses the associated sentence template and embedded global and local macros to generate at least one sentence for the node.

23. The method of claim 18, wherein no sentence is generated if a node is omitted by user.

24. The method of claim 18, further comprising the step of associating a default sentence template and a non-default sentence template terminal node.

25. The method of claim 24, wherein, a terminal node further comprises a formula that will be evaluated during the formation of the sentence.

26. The method of claim 24, wherein the default sentence template is used if user selects a default option presented at that node or at a higher associated node.

27. The method of claim 24, wherein the default sentence template comprises a natural-language statement summarizing a state of affairs with respect to the information provided by the user.

28. The method of claim 1, further comprising a user interface data entry screen operative to allow user viewing of generated sentences, user editing of such sentences, and saving of user edited sentences in the document repository, wherein the operation of the saving the edited sentence does not alter the underlying sentence template.

29. The method of claim 1, wherein data capture fields are selected from the group including but not limited to check boxes, radio buttons, data entry fields, drop down lists, pop up boxes, tab information selectors, and other equivalent user-interface information input devices.

30. The method of claim 1, further comprising steps for providing a user interface for user construction of sentence templates.

31. The method of claim 1, further comprising the step of creating and storing a style sheet for use in constructing the text document.

32. The method of claim 31, wherein the style sheet is a custom-made XSL file associated with a template.

33. The method of claim 32, wherein information from the findings repository and the document repository are made available via XML to make a customized report, the method further comprising the steps of:
(a) allowing a choice between using a customized style sheet or a predetermined generic style sheet to make a final customized report;
(b) storing the final customized report in a managed repository that requires the report to be checked out before editing and checked in after editing; and
(c) tracking versions of the final customized report as well as the identity of the user associated with each version of the customized report.

34. The method of claim 1, wherein the method is carried out using a plurality of workstations for receiving data entry from a plurality of different users.

35. A computer-implemented method for generating a natural-language, written document based on information input by a user in response to computer-assisted querying, comprising the steps of:
(a) storing a hierarchical arrangement of information queries arranged in a logical tree having non-terminal nodes and terminal nodes;
(b) displaying an information query comprising prompting information for prompting user input of particular information;
(c) in response to user input of particular information, determining that a related additional information query is applicable or that a terminal node has been reached;
(d) repeating the above steps (b) and (c) until a terminal node is reached;
(e) in response to a terminal node, storing data from user input of information in a findings repository; and
(f) upon reaching a final terminal node of the logical tree, generating a document by the steps of:
(i) retrieving a predetermined sentence template containing predetermined portions of a natural-language sentence or other grammatical structure, having embedded macros for receiving particular information stored in the findings repository and populating data fields in the template;
(ii) retrieving information corresponding to the embedded macros from the findings repository;
(iii) structuring the retrieved information into a list or concatenating the information into a phrase with proper separators and conjunctions for inclusion in a sentence;
(iv) populating the data fields in the template so as to provide a grammatically appropriate structure for a sentence; and
(v) storing a plurality of completed natural-language sentences as a part of a document in a document repository.

36. The computer-implemented method of claim 35, wherein the method is implemented at a web-enabled workstation.

37. The computer-implemented method of claim 35, wherein the grammatically appropriate structure comprises a natural-language syntax including grammar and punctuation.

38. The computer-implemented method of claim 35, wherein the questions are displayed to the user in a hierarchically arranged format so that the user can visually ascertain a parent/child relationship between a first question and at least one related question.

39. The computer-implemented method of claim 38, wherein a non-terminal node's immediate children must be either all non-terminal nodes or all terminal nodes.

40. The computer-implemented method of claim 35, wherein the step of determining that a related additional question is applicable comprises traversing the branches of a decision tree to a non-terminal node of the tree as a function of the particular information input by the user.

41. The computer-implemented method of claim 40, where in the event a non-terminal node is designated a repeater node the non-terminal node will upon user request dynamically replicate itself, complete with children, in order to allow the capture of multiple occurrences of similar data.

42. The computer-implemented method of claim 40, where in the event a non-terminal node is designated a selector node the non-terminal node will dynamically present different tree paths to the user depending upon the data entered.

43. The computer-implemented method of claim 35, further comprising the step of providing a document from the document repository as a report output.

44. The computer-implemented method of claim 35, wherein the step of providing a report output comprises displaying a report, printing a report, transmitting a report, or communicating the report to a computer workstation for further processing.

45. The computer-implemented method of claim 35, further comprising the step of providing information from the findings repository in response to a findings query.

46. The computer-implemented method of claim 35, wherein the sentence template is stored in a template repository.

47. The computer-implemented method of claim 46, wherein the user creates logical trees with sentence templates at its non-terminal nodes and data capture fields as terminal nodes.

48. The computer implemented method of claim 47, wherein a structured data entry screen template comprises one or more logical trees the logical trees being configured to capture structured data and generate sentences according to a predetermined set of rules.

49. The computer-implemented method of claim 48, wherein the logical tree nodes have local or global attributes that can be accessed through local or global macros, the scope of a local macro being limited to the logical tree where it is defined and global macros are available to all templates.

50. The computer-implemented method of claim 48, wherein a node can be a terminal node that includes at least one data capture field or a non-terminal node that is associated with a child node that is either a terminal node or a non-terminal node that eventually leads to a terminal node.

51. The computer-implemented method of claim 48, wherein the sentence generating rules include a rule that if a node does not have an associated sentence template, that node inherits sentences generated by a child node.

52. The computer-implemented method of claim 48, wherein the sentence generating rules include a rule that if a node has an associated sentence template, that node uses the associated sentence template and any embedded global and local macros to generate at least one sentence for the node.

53. The computer-implemented method of claim 48, wherein no sentence is generated if a node is omitted by user.

54. The computer-implemented method of claim 48, further comprising the step of associating a default sentence template or a non-default sentence template with a given particular non-terminal node.

55. The computer-implement method of claim 54, wherein the formulas in a descendent terminal node are evaluated as the associated default or non-default sentence is generated.

56. The computer-implemented method of claim 54, wherein the default sentence template is used if user selects a default option presented at that node or at a higher associated node.

57. The computer-implemented method of claim 56, wherein an element of the sentence can be configured to be optional and in the event that no data is input for the element, the element will be omitted.

58. The computer-implemented method of claim 57, wherein an optional element may be nested within other optional elements thus allowing for the construction of complex sentences that can be varied according to the data is entered.

59. The computer-implemented method of claim 54, wherein the default sentence template comprises a natural-language statement summarizing a state of affairs with respect to the information provided by the user.

60. The computer-implemented method of claim 35, further comprising a user interface data entry screen operative to allow user viewing of generated sentences, user editing of such sentences, and saving of user edited sentences in the document repository.

61. The computer-implemented method of claim 60, wherein the operation of saving the edited sentence does not alter the underlying sentence template.

62. The computer-implemented method of claim 35, further comprising steps for providing a user interface for user construction of sentence templates.

63. The computer-implemented method of claim 35, further comprising the step of creating and storing a style sheet for use in constructing the text document.

64. The computer-implemented method of claim 63, wherein the style sheet is represented in XML and/or XSL.

65. The computer-implemented method of claim 64, wherein information from the findings repository and the document repository are retrievable via XML to make a customized report, the computer-implemented method further comprising the steps of:
(a) allowing a choice between using a customized style sheet or a predetermined generic style sheet to make a customized final report;
(b) storing the customized final report in a managed repository that requires the report to be checked out before editing and checked in after editing; and
(c) tracking versions of the report as well as the identity of the user associated with each version.
